(19) United States
(12) Patent Application Publication
(10) Pub. No.: US 2004/0245066 A1
(43) Pub. Date: Dec. 9, 2004

(54) Bill handling system and bill handling method

(76) Inventors: Hiroshi Ichikawa, Owariasahi (JP); Riichi Katou, Nagoya (JP); Minoru Kadowaki, Toyota (JP); Atsuko Uozumi, Owariasahi (JP); Toshinori Yokoi, Nagakute (JP)

Correspondence Address: MCDERMOTT, WILL & EMERY, 600 13th Street, N.W., Washington, DC, 20005-3096, US

(21) Appl. No.: 10/822,864

(22) Filed: Apr. 13, 2004

(30) Foreign Application Priority Data
Apr. 14, 2003 (JP) 2003-109209(P)

(51) Int. Cl. G07F 7/04; G06K 7/00; G07D 7/00; G06K 9/00

(52) U.S. Cl. 194/206

(57) ABSTRACT

In the case of detection of any counterfeit banknote in a transaction process other than a deposit transaction, the banknote handling system of the invention identifies a transactor who uses the counterfeit banknote. The banknote handling system comprises: a money in-out slot that receives insertion of banknotes from each customer; a conveyance module that conveys each banknote; multiple banknote discrimination modules that carry out banknote discrimination of each conveyed banknote in a money-in process that pay in banknotes inserted in the money in-out slot, as well as in another transaction process that is accompanied with conveyance of banknotes; a banknote storage box that stores a banknote determined as genuine by the banknote discrimination module; a collection box that collects a banknote determined as counterfeit by the banknote discrimination module; and a management module that manages information on the transaction process with respect to each banknote.

### BACKGROUND OF THE INVENTION

The present invention relates to a banknote handling device that handles various transactions including deposits and withdrawals of banknotes.

Banknote handling devices are used in various financial institutions to receive and give banknotes from and to customers. A proposed banknote handling device carries out banknote discrimination to determine each banknote received for a transaction as genuine or as counterfeit (non-genuine) and prints out a result of the banknote discrimination of the banknotes used for the transaction while returning the banknotes determined as counterfeit to the customer (see Japanese Patent Laid-Open Gazette No. 53-83686). When banknotes received from a customer for a transaction include a preset or greater number of banknotes determined as counterfeit, another proposed banknote handling device takes all the received banknotes in a banknote storage box, as well as a passbook and a card used for the transaction (see Japanese Patent Laid-Open Gazette No. 2001-143120).

### SUMMARY OF THE INVENTION

The prior art banknote handling device carries out banknote discrimination only at the time of a deposit transaction and accordingly has relatively low accuracy of banknote discrimination. In the case of detection of a counterfeit banknote, the prior art banknote handling device has difficulties in identifying the user who uses the counterfeit banknote and thus can not sufficiently prevent circulation of counterfeit banknotes.

In order to resolve at least part of these drawbacks of these prior art techniques, the invention is directed to a banknote handling system, which includes: a banknote discrimination module that carries out banknote discrimination of each banknote in at least one transaction process that is accompanied with conveyance of banknotes, in addition to a money-in process that pays in banknotes received from a customer; multiple banknote storage boxes that store banknotes used in the transaction process; a collection box that collects a counterfeit banknote in a non-returnable manner to the customer; and a forgery processing module that collects an undeterminable banknote as well as the counterfeit banknote in the collection box, based on a result of the banknote discrimination.

### BRIEF DESCRIPTION OF THE DRAWINGS

FIG. 1 is an explanatory view illustrating the system configuration of an automatic teller machine 10 in a first embodiment;

FIG. 2 is an explanatory view schematically illustrating the structure of a banknote handling mechanism 20 in the first embodiment;

FIG. 3 is an explanatory view schematically illustrating the structure of the banknote handling mechanism 20 in the first embodiment;

FIG. 4 is a functional block diagram showing a control unit 200 in the first embodiment;

FIG. 5 is an explanatory view schematically showing respective databases in a host computer 1000 in the first embodiment;

FIG. 6 is an explanatory view schematically showing an example of source data 210 in the first embodiment;

FIG. 7 is a flowchart showing a money-in routine executed in the first embodiment;

FIG. 8 is a flowchart showing a banknote feed routine executed in the first embodiment;

FIG. 9 is an explanatory view schematically illustrating the structure of the banknote handling mechanism 20 in a second embodiment;

FIG. 10 is a flowchart showing a money-out routine executed in the second embodiment;

FIG. 11 is a diagram showing a source data update process in the second embodiment;

FIG. 12 is an explanatory view schematically illustrating the structure of the banknote handling mechanism 20 in one modified example; and

FIG. 13 is an explanatory view schematically illustrating the structure of the banknote handling mechanism 20 in another modified example.

### DESCRIPTION OF THE PREFERRED EMBODIMENTS

The technique of the invention carries out banknote discrimination of each banknote in a transaction process accompanied with conveyance of banknotes in the banknote handling device. This arrangement desirably enhances the accuracy of banknote discrimination. Banknotes determined as counterfeit and undeterminable banknotes are collected in a non-returnable manner. This arrangement effectively prevents circulation of counterfeit banknotes. When banknotes paid in by a customer include any counterfeit banknotes, the counterfeit banknotes are collected in a non-returnable manner. Information regarding the sum of money paid in by the customer is displayed on a monitor and is written in a transaction statement. The customer is thus notified of the sum of money deposited. This improves the convenience for the customer.

In the banknote handling device of the invention, the transaction process other than the money-in process may be at least part of a cancellation process to allow a customer to cancel a deposit, a money-out process that pays out banknotes to a customer, a left-money collection process that collects a banknote carelessly left behind by a customer, a banknote feed process that feeds banknotes to a banknote feed box attached to the banknote handling device, and a collection process that collects banknotes from a banknote collection box detached from the banknote handling device.

Banknote discrimination in various transaction processes desirably heightens the accuracy of banknote discrimination and more effectively prevents circulation of counterfeit (non-genuine) banknotes.

The banknote handling device of the invention may further have a management module that manages source information for identifying a source of each banknote, which is used in each transaction process and is collected in the collection box, corresponding to the banknote. The source information includes at least transactor information for identifying a transactor responsible for each transaction process, for example, an account number and the name of a customer or an employee number of an employee who has fed banknotes. Such management enables the source of each detected counterfeit banknote to be traced as the customer's deposit or as the banknote feed process. This arrangement advantageously prevents circulation of counterfeit banknotes.

The banknote handling device of the invention may further include a transaction record reference module that refers to a transaction record with identification information individually assigned to each transaction process. The management module manages this identification information as the source information. The identification information may be a serial number allocated to each transaction record or a number allocated at random. The identification information may be a combination of English alphabets, numerals, and Japanese characters. The identification information may have any form that ensures unequivocal identification of each transaction record. The transaction record may be managed in the banknote handling device or in a host computer, which is connected with the banknote handling device via a communication line. The latter arrangement reduces the amount of the source information managed by the management module, while ensuring easy identification of the source information, thus improving the convenience of the banknote handling device.

In the banknote handling device of the invention, the management module carries out the management in the unit of banknotes with respect to each of the banknote storage boxes. The banknote handling device may further include an information update module that updates the information managed by the management module, based on a result of banknote discrimination in any of the money-out process, the left-money collection process, the banknote feed process, and the collection process. When a banknote, which is once stored in one of the banknote storage boxes but is determined as counterfeit, for example, in the money-out process, this arrangement desirably enables the source of each counterfeit banknote to be identified.

The arrangements of the banknote handling device discussed above may be combined appropriately. The technique of the invention is not restricted to the banknote handling device discussed above, but may be actualized by diversity of other applications, for example, a banknote management method, a computer program to attain banknote management, and a computer readable recording medium in which such a computer program is recorded. Available examples of the recording medium include flexible disks, CD-ROMs, DVD-ROMs, magneto-optic discs, IC cards, ROM cartridges, punched cards, prints with barcodes and other codes printed thereon, internal storage devices (memories like RAM and ROM) and external storage devices of the computer, and other diverse computer readable media.

### A. First Embodiment

A1. System Configuration

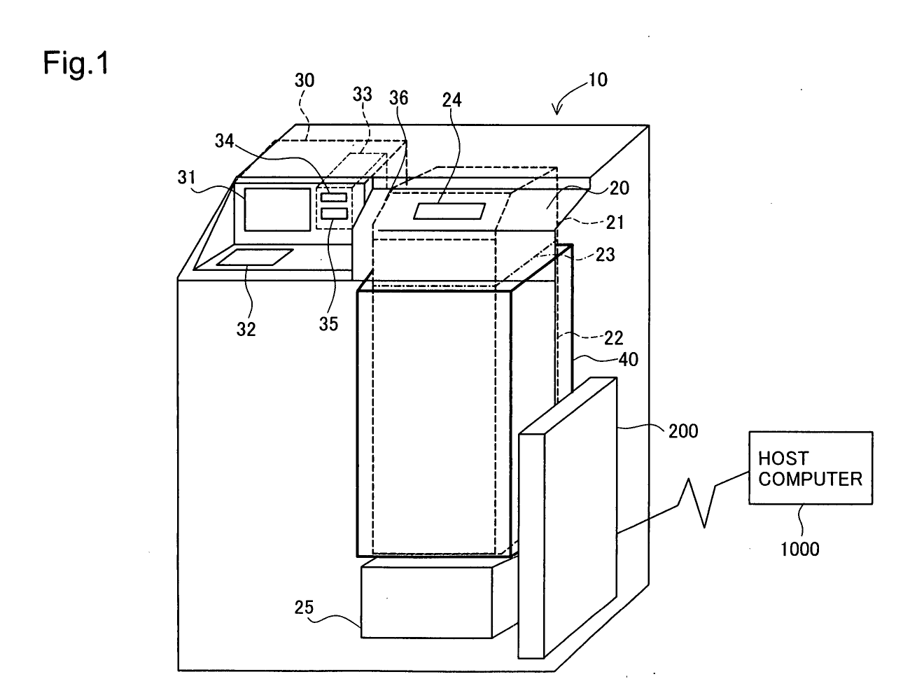

FIG. 1 is an explanatory view illustrating the system configuration of an automatic teller machine 10 in a first embodiment. The automatic teller machine 10 is located in banks and other financial institutions for automated transactions in response to customers' operations. The transactions include deposits to customers' accounts, withdrawals from customers' accounts, and transfers to other accounts. This embodiment especially regards a series of processing executed when banknotes paid in for a deposit transaction or in a banknote feed operation include some counterfeits.

The automatic teller machine 10 of this embodiment has a banknote handling mechanism 20, a feed-collection cassette module 25, a transaction processing assembly 30, and a control unit 200.

The banknote handling mechanism 20 has a money in/out module 21 above a one-dot chain line 23 and a banknote storage module 22 below the one-dot chain line 23. The money in/out module 21 has a cover 36. For the security, the banknote storage module 22 that stores cash money is located inside a safe 40. The feed-collection cassette module 25 is designed to ensure easy attachment and detachment of a cassette when the clerk at the financial institution feeds banknotes into the automatic teller machine 10 and collects banknotes from the automatic teller machine 10. Banknotes are received from and given to each customer through a banknote in-out slot 24 formed in the cover 36. In a deposit transaction, when the customer inserts banknotes into the banknote in-out slot 24, the money in/out module 21 discriminates forgery or counterfeit banknotes from genuine banknotes, classifies the genuine banknotes by the banknote type, and stores the classified genuine banknotes in the banknote storage module 22. The counterfeit banknotes are collected in a forgery collection box. In a withdrawal transaction, banknotes corresponding to the customer's specified amount of money are withdrawn from the banknote storage module 22 and are given to the customer through the banknote in-out slot 24. The counterfeit banknotes collected in the forgery collection box are not mistakenly returned to the customer or used for withdrawal transactions.

The transaction processing assembly 30 includes a display panel 31, an input unit 32, and a medium processing module 33. The display panel 31 gives display of information and a message relating to a current transaction to the customer. The input unit 32 functions as an interface to be manipulated for the transaction and has push button switches in the structure of this embodiment. Although the display panel 31 is separate from the input unit 32 in the structure of this embodiment, the display panel 31 may alternatively be structured as a touch panel and be integrated with the input unit 32.

The medium processing module 33 has a card slot 34 and a form acceptance unit 35 and acquires customer information regarding each customer who requires a transaction from any of various cards inserted in the card slot 34 and passbooks inserted in the form acceptance unit 35. The customer information includes, for example, an account number for identifying the account of the customer and a secret identification code. The card may be any of ATM cards, credit cards, and IC cards. The medium processing module 33 also has an employee card slot for reading employee information from an employee ID card. The medium processing module 33 functions to output a transaction statement showing written results of each transaction and to print the details of the transaction on the customer's passbook, in addition to acquisition of the customer information.

The operations of the respective units included in the automatic teller machine 10 discussed above are under control of the control unit 200. The control unit 200 is constructed as a microcomputer including a CPU and memories and receives and sends information from and to these units to control the operations of the whole automatic teller machine 10. The control unit 200 is connected with a host computer 1000 via a communication line. The control unit 200 establishes communication with the host computer 1000 to effectuate money-in and money-out transactions.

A2. Banknote Handling Mechanism

The banknote handling mechanism 20 includes the money in/out module 21, the banknote storage module 22, and the feed-collection cassette module 25 as mentioned above. The following description regards the processing executed by the respective units in the course of a deposit transaction and a banknote feed operation.

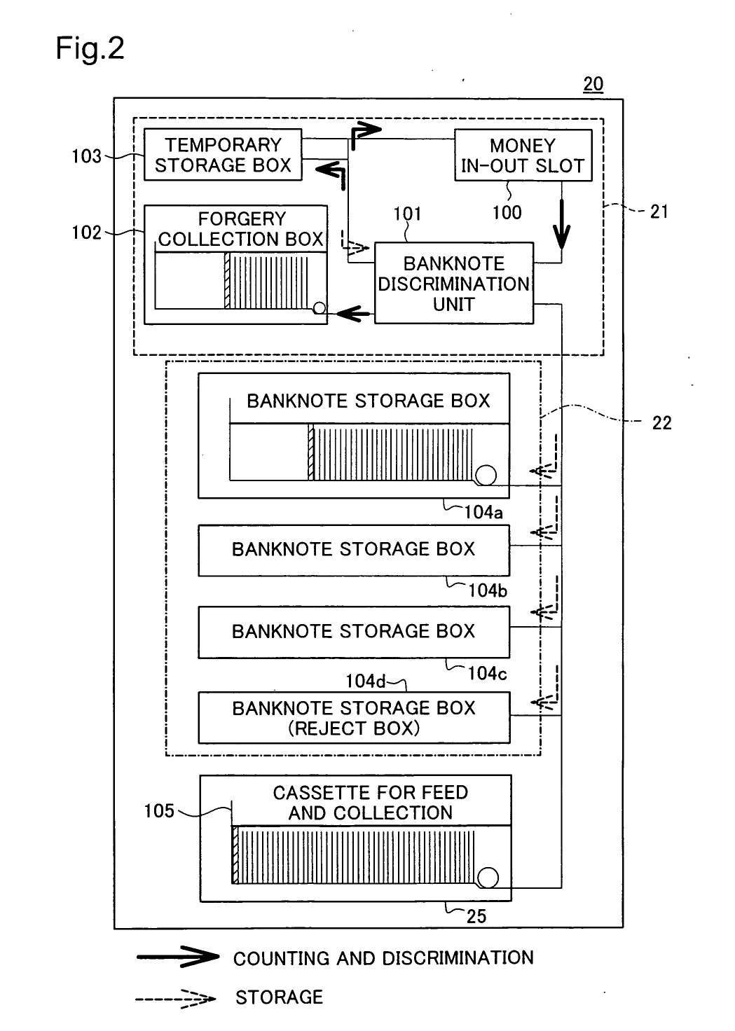

FIG. 2 is an explanatory view showing a series of processing in the banknote handling mechanism 20 for a deposit transaction. The thin lines interconnecting the respective units show a banknote conveyor path for conveyance of banknotes. The arrows of thick line show the flow of banknotes for a received-money counting and discrimination process in the deposit transaction. The arrows of broken-line show the flow of banknotes for a received-money storage process in the deposit transaction. The conveyor path is driven, for example, by a motor, a pulley, and a belt. The received-money counting process counts up the number of banknotes received from a customer in each deposit transaction by the respective banknote types. The received-money storage process stores the counted banknotes into the banknote storage module 22.

The money in/out module 21 has a money in-out slot 100, a banknote discrimination unit 101, a forgery collection box 102, and a temporary storage box 103. The banknote storage module 22 has four banknote storage boxes 104a, 104b, 104c, and 104d for storing banknotes classified by the banknote type. In the structure of this embodiment, 10000 yen bills, 5000 yen bills, and 1000 yen bills are respectively stored in the banknote storage box 104a, in the banknote storage box 104b, and the banknote storage box 104c, while the banknote storage box 104d stores banknotes failed to be determined as genuine or as counterfeit (hereafter referred to as undeterminable banknotes) and banknotes that are not storable in any of the banknote storage boxes 104a through 104c, for example, 2000 yen bills. The undeterminable banknote is torn, is stuck to another banknote, or is stained and thus fails to be determined as genuine or as counterfeit. Hereafter the banknote storage box 104d is called the reject box 104d. A cassette 105 is used for a banknote feed operation and a banknote collection operation and is readily attached to and detached from the feed-collection cassette module 25. The banknote feed operation feeds in banknotes from the cassette 105, in which banknotes are stored in advance, to the automatic teller machine 10. The banknote collection operation feeds out the banknotes from the automatic teller machine 10 to the cassette 105. The cassette 105 is detached for collection of banknotes.

Banknotes are received from and given to each customer via the money in-out slot 100. The banknotes inserted into the money in-out slot 100 at the time of a deposit transaction are separately conveyed to the banknote discrimination unit 101. The banknote discrimination unit 101 functions to carry out banknote discrimination and determine each banknote as counterfeit or as genuine. The banknotes determined as counterfeit by the banknote discrimination unit 101 are collected into the forgery collection box 102. The forgery collection box 102 is designed to prohibit the collected counterfeit banknotes from being returned to the customer.

The banknotes determined as genuine by the banknote discrimination unit 101 are temporarily kept in the temporary storage box 103 until settlement of the current transaction. The undeterminable banknotes are returned to the money in-out slot 100. The series of processing to this stage is called the ‘received-money counting process’ shown by the arrows of thick line. On completion of the received-money counting process, the ‘received-money storage process’ shown by the arrows of broken line is carried out to send the banknotes temporarily kept in the temporary storage box 103 to the banknote storage module 22. The received-money storage process conveys each banknote to the corresponding one of the banknote storage boxes 104a through 104c and the reject box 104d for storage, in response to the customer's deposit instruction.

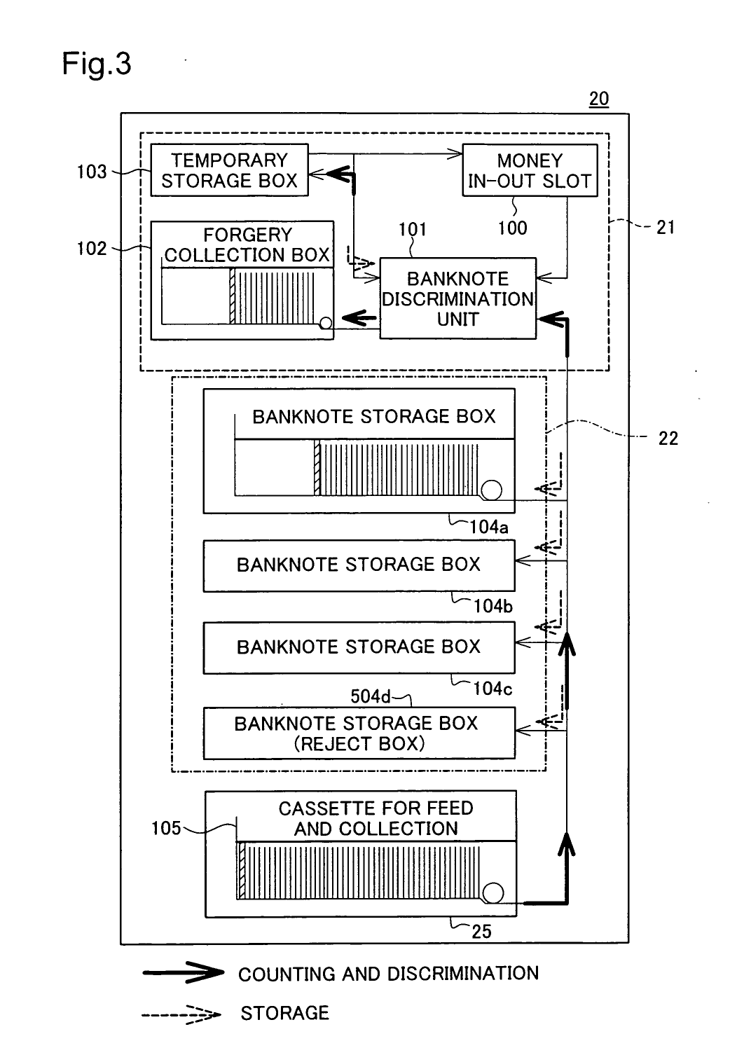

FIG. 3 is an explanatory view showing a series of processing in the banknote handling mechanism 20 for a banknote feed operation in this embodiment. The arrows of thick line show the flow of banknotes for a discrimination process in the banknote feed operation. The arrows of broken-line show the flow of banknotes for a storage process in the banknote feed operation.

When the clerk at the financial institution attaches the cassette 105 to the feed-collection cassette module 25, the banknotes are successively fed one by one to the banknote discrimination unit 101 as shown by the arrows of thick line. The banknotes determined as counterfeit by the banknote discrimination unit 101 are collected into the forgery collection box 102. The banknotes determined as genuine or undeterminable by the banknote discrimination unit 101 are temporarily kept in the temporary storage box 103 until completion of discrimination for all the banknotes stored in the cassette 105. The series of processing to this stage is called the ‘discrimination process’ shown by the arrows of thick line.

On completion of the discrimination process, the ‘storage process’ shown by the arrows of broken line is carried out to send the banknotes temporarily kept in the temporary storage box 103 to the banknote storage module 22. The storage process conveys each banknote determined as genuine, among the banknotes kept in the temporary storage box 103, to the corresponding one of the banknote storage boxes 104a through 104c for storage, while conveying each undeterminable banknote to the reject box 104d for storage.

A3. Functional Block

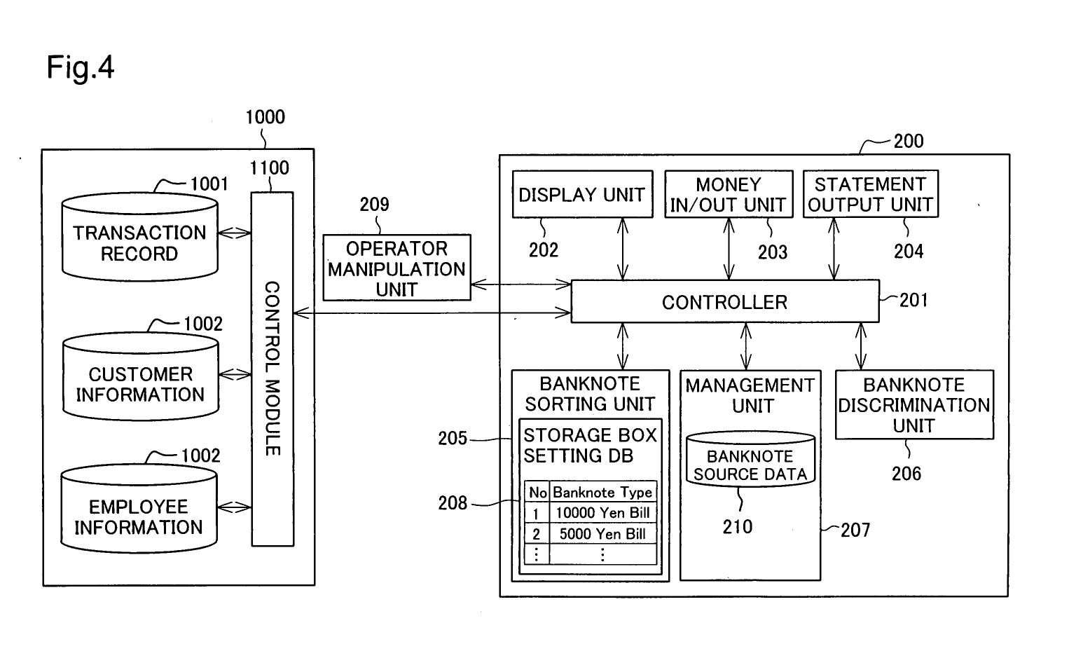

FIG. 4 shows functional blocks of the control unit 200. In this embodiment, the respective functional blocks are attained by the software configuration in the control unit 200 and are controlled by a controller 201. The respective functional blocks may alternatively be actualized by the hardware construction. FIG. 4 also shows functional blocks of the host computer 1000.

The control unit 200 includes a controller 201, a display unit 202, a money in/out unit 203, a statement output unit 204, a banknote sorting unit 205, a banknote discrimination unit 206, a management unit 207, a storage box setting DB (database) 208 incorporated in the banknote sorting unit 205, and banknote source data 210 incorporated in the management unit 207.

The controller 201 controls the other functional blocks included in the control unit 200, while controlling conveyance of banknotes and operations of the respective storage boxes, that is, the banknote storage boxes 104a to 104d, the forgery collection box 102, and the temporary storage box 103. The controller 201 also functions to receive and send information from and to the host computer 1000. For example, the controller 201 creates a transaction record ID at the start of each transaction and transfers its transaction record to the host computer 1000 at the end of the transaction.

The host computer 1000 includes a control module 100 and three databases, a transaction record database 1001, a customer information database 1002, and an employee information database 1003. The control module 1100 receives and sends information from and to the controller 201 of the automatic teller machine 10, while managing the respective databases. Examples of the information managed in the respective databases are shown in FIG. 4.

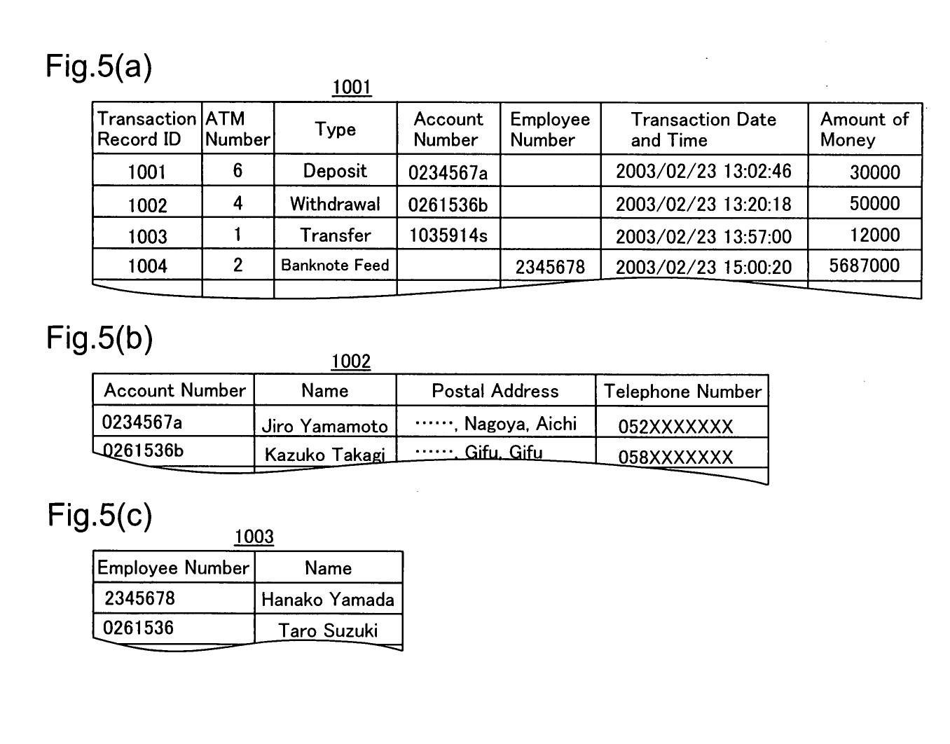

FIG. 5 is an explanatory view showing the structures and the contents of the respective databases managed in the host computer 1000. FIG. 5(a) is an explanatory view showing an example of the transaction record 1001. Each record in the transaction record 1001 has seven columns, a transaction record ID, an ATM number, a transaction type, an account number, an employee number, transaction date and time, and an amount of money. The transaction record ID is a number allocated to each transaction record in an unequivocally identifiable manner. The ATM number is a number assigned to each automatic teller machine to identify the automatic teller machine used for the transaction. The transaction type represents the type of each transaction. The account number is a number assigned to an account of a customer who made each transaction, when the transaction type is other than the banknote feed operation or the banknote collection operation but represents a transaction with the customer. The employee number is a number given to each employee at the financial institution who carried out a banknote feed operation or a banknote collection operation. The amount of money represents the sum of money involved in the transaction or the banknote feed or collection operation. In the case of the banknote feed operation or the banknote collection operation, there is no transmission of money or information to and from any customer. The account number column is accordingly kept vacant. In the case of any transaction other than the banknote feed operation or the banknote collection operation, the employee number column is kept vacant.

FIG. 5(b) is an explanatory view showing an example of the customer information 1002. Each record in the customer information 1002 has four columns, the account number, the name, the postal address, and the telephone number of each customer. The account number column in the transaction record 1001 is related to the account number column in the customer information 1002. The detailed information on each customer included in the transaction record 1001 is obtained by retrieving a record in the customer information 1002 having the account number identical with the account number in the transaction record 1001. For example, a deposit transaction with a transaction record ID ‘1001’ was made by a customer having an account number ‘0234567a’. The customer having this account number is identified in the customer information 1002 as the name ‘Jiro Yamamoto’, the postal address ‘ . . . , Nagoya, Aichi’, and the telephone number ‘052-XXX-XXXX’.

FIG. 5(c) is an explanatory view showing an example of the employee information 1003. Each record in the employee information 1003 has two columns, the employee number and the name of each employee. The employee number column in the transaction record 1001 is related to the employee number column in the employee information 1003. The name of each employee included in the transaction record 1001 is identified by retrieving a record in the employee information 1003 having the employee number identical with the employee number in the transaction record 1001. For example, a banknote feed operation with a transaction record ID ‘1004’ was carried out by an employee having an employee number ‘2345678’. The employee having this employee number is identified in the employee information 1003 as the name ‘Hanako Yamada’.

Referring back to FIG. 4, the other functional blocks of the control unit 200 in the automatic teller machine 10 are described. The display unit 202 functions to generate and output information, which is to be displayed on the display panel 31. In this embodiment, the information to be displayed includes the total amount of money received from the customer, the types of the banknotes received and their numbers, the number of genuine banknotes, and the amount of money settled as the deposit transaction. Part of these pieces of information may be omitted from the display, or other required pieces of information may be displayed additionally. The statement output unit 204 prints the details of the transaction on a form and outputs the printed form. In the case of a deposit transaction, the details of the transaction to be printed include the date of the transaction, the name of the customer, the account number, the specification of the transaction, the amount of money received, the results of banknote discrimination of the banknotes received from the customer, and the amount of money settled as the deposit transaction.

The money in/out unit 203 detects insertion of banknotes into the money in-out slot 100. In response to detection of banknotes by the money in/out unit 203, the controller 201 conveys the banknotes to the banknote discrimination unit 206. The banknote discrimination unit 206 determines each banknote as genuine or counterfeit, specifies the banknote type and the damage status of each banknote, and keeps the results of discrimination. The banknote discrimination unit 206 also counts up the number of each type of banknotes and keeps the results of counting, in addition to the results of discrimination (hereafter these results are collectively referred to as the results of discrimination).

The banknote sorting unit 205 sorts out the respective banknotes, based on the results of discrimination by the banknote discrimination unit 206 and the contents of the storage box setting DB 208. The banknote sorting unit 205 gives a conveyance instruction to the controller 201 to convey the banknotes according to the results of sorting. The controller 201 receives the conveyance instruction and conveys and stores the banknotes.

The storage box setting DB 208 is constructed as part of the banknote sorting unit 205, and manages the mapping of the number allocated to each storage box to the type of the banknotes to be stored in the storage box, which is stored in the form of a table. The numeral ‘0’ is allocated to the forgery collection box 102. The numerals ‘1, 2, 3, . . . ’ are sequentially allocated to the banknote storage boxes according to their locations in the banknote storage module 22. For example, in the structure of this embodiment, the numeral ‘1’ is given to the banknote storage box 104a, and the numeral ‘2’ to the banknote storage box 104b.

The management unit 207 generates the banknote source data 210, based on the results of discrimination by the banknote discrimination unit 206 and the results of sorting by the banknote sorting unit 205. The banknote source data 210 are used to manage the source of each banknote stored in each banknote storage box, that is, information for identifying a person who has given the banknote, with respect to each banknote storage box. The banknote storage box here includes the forgery collection box 102. The banknote source data 210 will be discussed in detail later.

An operator manipulation unit 209 is provided on the rear face of the banknote handling mechanism 20 and functions to effectuate the settings in the storage box setting DB 208 via the controller 201. For example, the operator may specify ‘1000 yen’ as the banknote type to be stored in the banknote storage box 104a having the numeral ‘1’ allocated thereto. The operator can flexibly change the settings in the storage box setting DB 208 according to the requirements.

A4. Banknote Source Data

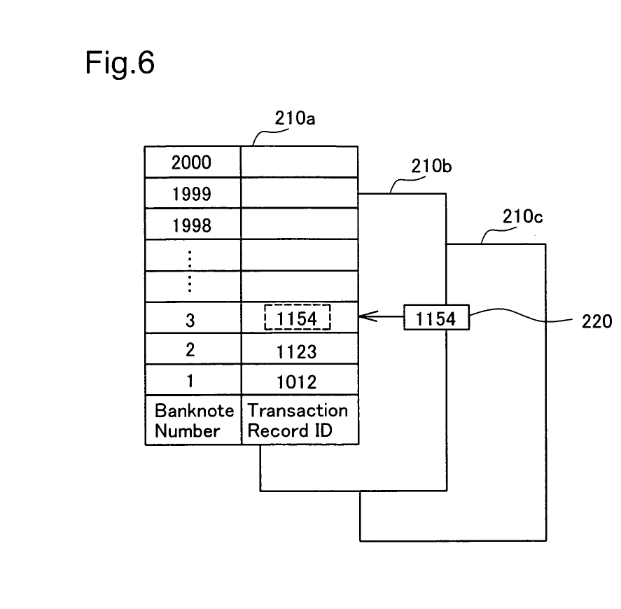

FIG. 6 is an explanatory view showing an example of the banknote source data 210. The banknote source data 210 are managed in the unit of banknotes with respect to each banknote storage box. In the structure of this embodiment, each banknote storage box has the capacity of storing up to 2000 bills, and banknote numbers ‘1’ to ‘2000’ are allocated in the ascending order to the banknotes received therein. Banknote source data 210a with respect to the forgery collection box 102 are described as an example.

In a left column of the banknote source data 210a, banknote numbers ‘1’ to ‘2000’ are given corresponding to banknotes in the forgery collection box 102 in their storage order. As illustrated, the banknote numbers are given from the bottom in the ascending order. Transaction record IDs allocated to respective transactions, in which the banknotes corresponding to the respective banknote numbers were used, are stored in a right column of the banknote source data 210a. For example, the banknote having the banknote number ‘2’ was used in a transaction having a transaction record ID ‘1123’. The banknote source data 210a are constructed in a stack in a field having the capacity of storing banknote numbers and corresponding transaction record IDs for 2000 bills. When there is no banknote corresponding to the banknote number in the banknote source data 210a, the corresponding transaction record ID column is kept vacant.

When the banknotes used in a transaction having a transaction record ID ‘1154’ include any forgery, the control unit 200 conveys the banknote determined as counterfeit to the forgery collection box 102 and stores the transaction record ID ‘1154’ into the banknote source data 210a. In the illustrated example, the transaction record IDs have already been stored corresponding to the banknote numbers ‘1’ and ‘2’ in the banknote source data 210a, and the transaction record ID ‘1154’ is accordingly stored corresponding to the banknote number ‘3’. The storage in the banknote source data 210a thus clearly shows that the third banknote stored in the forgery collection box 102 was used in the transaction having the transaction record ID ‘1154’. Banknote source data 210b through 210e (only banknote source data 210a and 210b are shown in the drawing) corresponding to the banknote storage boxes 104a through 104d have the similar structure.

A5. Money-In Process

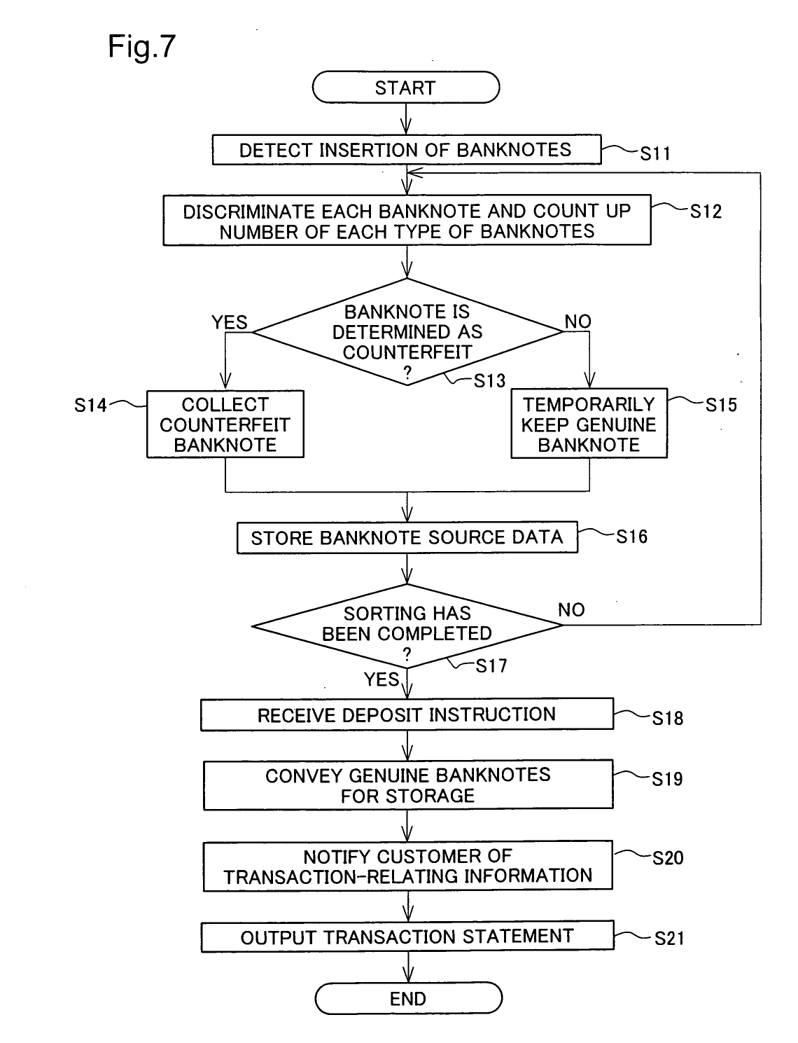

FIG. 7 is a flowchart showing a money-in routine executed in the first embodiment. The following description regards a series of processing when the banknotes received from a customer include any counterfeit banknote. The controller 201 controls the respective functional blocks to execute this money-in routine. The money-in routine starts when banknotes are inserted into the money in-out slot 100.

The control unit 200 detects insertion of banknotes (step S11), separates the paid-in banknotes one by one, discriminates each banknote, and counts up the number of each type of banknotes (step S12). The control unit 200 determines each banknote as genuine or as counterfeit (step S13). The banknote determined as counterfeit is collected in the forgery collection box 102 (step S14). The banknote determined as genuine is temporarily kept in the temporary storage box 103 (step S15). The undeterminable banknote is returned to the money in-out slot 100, if there is any. At this moment, the banknotes determined as counterfeit may also be kept in the temporary storage box 103.

The control unit 200 subsequently stores the banknote source data 210, based on the results of discrimination and the results of sorting (step S16). The control unit 200 then determines whether all the paid-in banknotes have been sorted out (step S17). When the sorting has not yet been completed, the control unit 200 returns the processing to step S12 and subsequent steps to sort out and discriminate a next banknote and store the banknote source data 210. When the sorting has been completed, on the other hand, the control unit 200 receives the customer's deposit instruction (step S18) and conveys the banknotes temporarily kept in the temporary storage box 103 to be stored in the corresponding banknote storage boxes 104a to 104c (step S19).

On completion of storage of the banknotes, the control unit 200 notifies the customer of the information regarding a deposit transaction in the form of a message window on the display panel 31 (step S20). The information includes the total amount of money received from the customer, the number of banknotes determined as genuine among the banknotes received from the customer, and the amount of money settled as the deposit transaction. The control unit 200 also outputs a transaction statement (step S21) and concludes the money-in routine.

A6. Banknote Feed Process

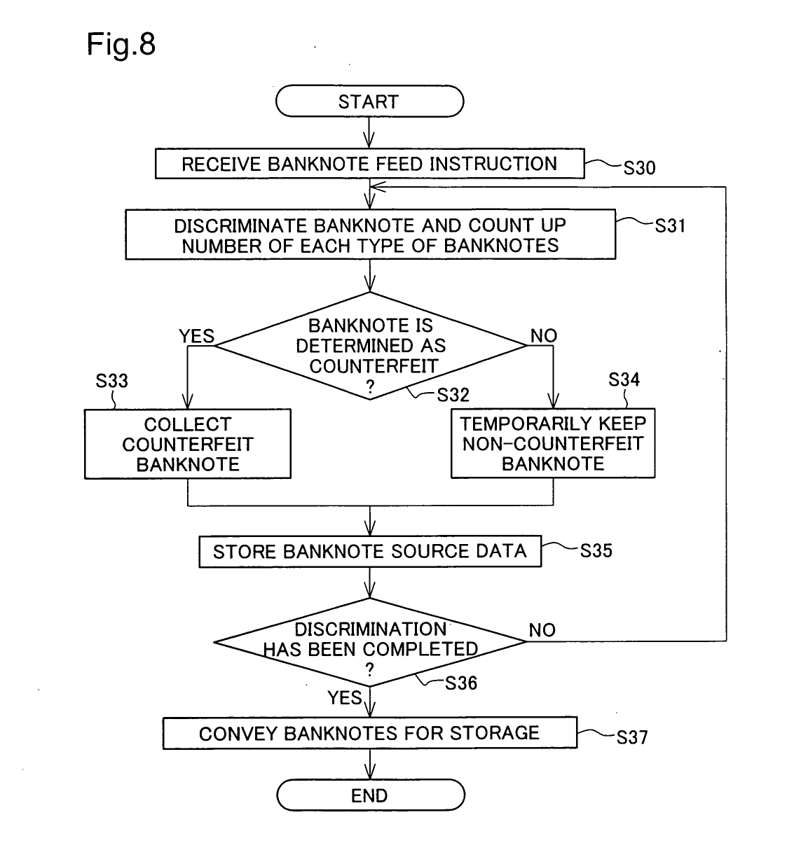

FIG. 8 is a flowchart showing a banknote feed routine executed in the first embodiment. The following description regards a series of processing when the banknotes fed by the clerk include any counterfeit banknote. The controller 201 controls the respective functional blocks to execute this banknote feed routine. The banknote feed routine starts when the cassette 105 is attached to the feed-collection cassette module 25.

The control unit 200 receives a banknote feed instruction (step S30), feed a banknote from the cassette 105, discriminates the banknote, and counts up the number of each type of banknotes (step S31). The result of discrimination is kept here. The control unit 200 determines the banknote as genuine or as counterfeit (step S32). The banknote determined as counterfeit is collected in the forgery collection box 102 (step S33). The banknote determined as non-counterfeit is temporarily kept in the temporary storage box 103 (step S34).

The control unit 200 subsequently stores the banknote source data 210, based on the result of discrimination (step S35). The control unit 200 then determines whether discrimination of all the paid-in banknotes has been completed (step S36). When the discrimination has not yet been completed, the control unit 200 returns the processing to step S31 and subsequent steps to sort out and discriminate a next banknote and store the banknote source data 210. When the discrimination has been completed, on the other hand, the control unit 200 conveys the banknotes determined as genuine, among banknotes temporarily kept in the temporary storage box 103, to the corresponding banknote storage boxes 104a to 104c for storage, while conveying any undeterminable banknotes to the reject box 104d for storage (step S37).

As described above, the automatic teller machine 10 of the first embodiment carries out banknote discrimination of banknotes at the time of each banknote feed operation as well as at the time of each deposit transaction, thus enhancing the accuracy of banknote discrimination (forgery detection and/or genuine detection). The automatic teller machine 10 manages banknote source data, regardless of the results of discrimination. This arrangement ensures identification of the customer who has paid in any counterfeit banknote and thus effectively prevents circulation of counterfeit banknotes.

In the first embodiment discussed above, discrimination of banknotes is not carried out in the banknote storage process at step S19 in the flowchart of FIG. 7 or at step S37 in the flowchart of FIG. 8. One preferable modification discriminates each banknote in this banknote storage process and stores any undeterminable banknote in the reject box and any counterfeit banknote in the temporary storage box. In this modified procedure, discrimination of banknotes is carried out twice both in the deposit transaction and in the banknote discrimination operation. This arrangement thus further enhances the accuracy of banknote discrimination.

### B. Second Embodiment

The procedure of the first embodiment discriminates banknotes at the time of each deposit transaction and at the time of each banknote feed operation and manages banknote source data. Any banknotes determined as counterfeit are collected to forbid circulation. A second embodiment of the invention carries out discrimination of banknotes at the time of each withdrawal transaction, as well as at the time of each deposit transaction and at the time of each banknote feed operation, and updates the banknote source data based on the results of discrimination. The money-in process and the banknote feed process of the second embodiment are identical with those of the first embodiment and are not specifically described here.

B1. Banknote Handling Mechanism

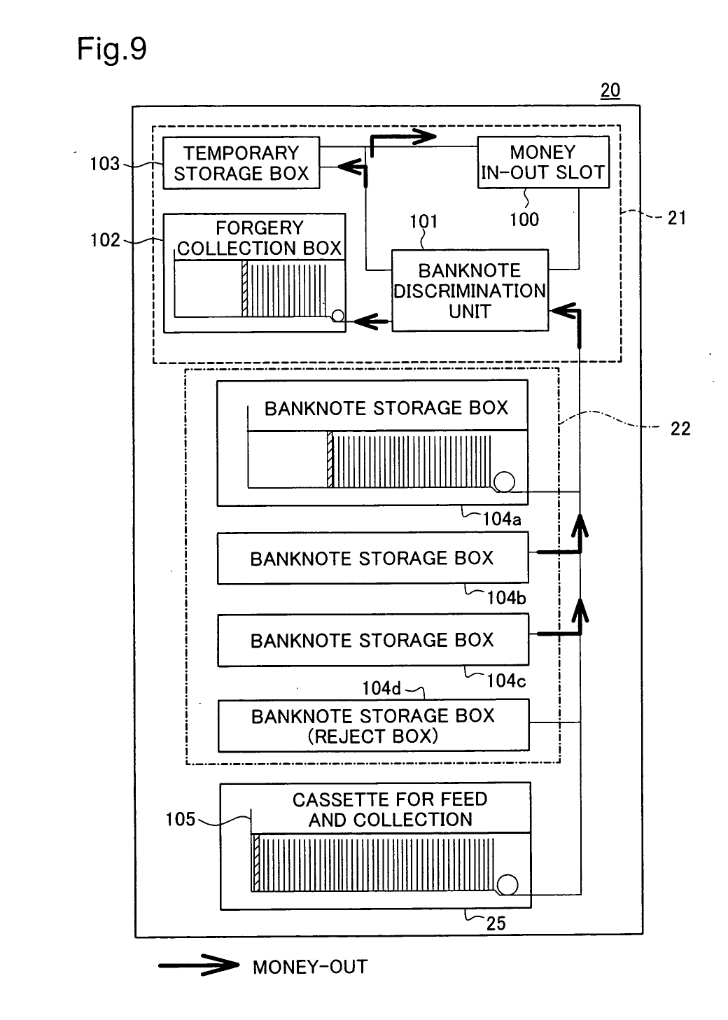

FIG. 9 is an explanatory view schematically illustrating the structure of the banknote handling mechanism 20 in the second embodiment. The structure of the banknote handling mechanism 20 in the second embodiment is identical with that in the first embodiment. The following describes a series of processing in the banknote handling mechanism for a withdrawal transaction. In this embodiment, the thin lines interconnecting the respective units show a banknote conveyor path for conveyance of banknotes. The arrows of thick line show the flow of banknotes for a money-out process including discrimination. The arrows of broken-line show the flow of banknotes for a left-money collection process. The left-money collection process collects banknotes, which were paid out to the money in-out slot 100 but were left by the customer, and restores the collected banknotes in the corresponding banknote storage boxes 104a through 104d.

In a withdrawal transaction, in response to the customer's withdrawal instruction, required banknotes are conveyed one by one from the corresponding banknote storage boxes 104a through 104c to the banknote discrimination unit 101, as shown by the arrows of thick line. Any banknote determined as counterfeit by the banknote discrimination unit 101 is collected in the forgery collection box 102. Any banknote determined as genuine by the banknote discrimination unit 101 is conveyed to the money in-out slot 100. Any undeterminable banknote is temporarily kept in the temporary storage box 103. The processing to this stage is shown by the arrows of thick line. The banknotes temporarily kept in the temporary storage box 103 are conveyed to the reject box 104d for storage after the money-out process. This series of processing is called the ‘money-out process’.

When any banknote is left at the money in-out slot 100 even after elapse of a preset time since the money-out process, it is determined that the customer carelessly leaves the banknote behind. The left-banknotes are separated one by one and are conveyed to the banknote discrimination unit 101 for discrimination as shown by the broken line. The subsequent processing is identical with that in the money-in process.

B2. Money-Out Process

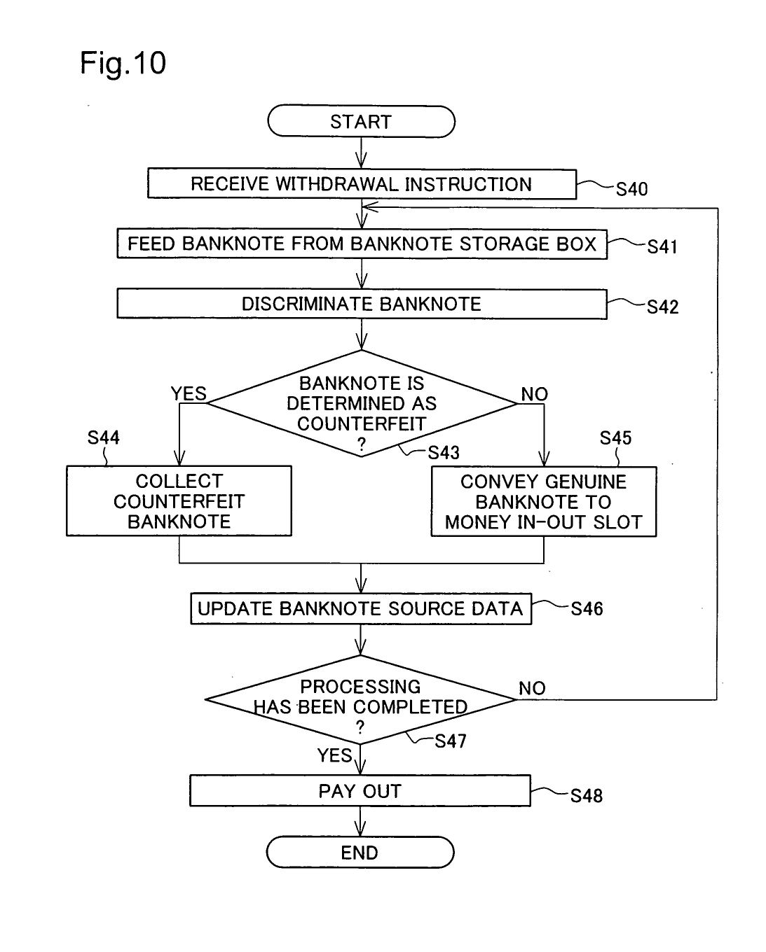

FIG. 10 is a flowchart showing a money-out routine executed in the second embodiment. The following description regards a series of processing when the banknotes fed from the banknote storage boxes 104a through 104c include any counterfeit banknote. The controller 201 controls the respective functional blocks to execute this money-out routine. The money-out routine starts, in response to the customer's withdrawal instruction.

The control unit 200 receives the customer's withdrawal instruction (step S40) and feeds a banknotes from the corresponding banknote storage box (step S41), and discriminates the banknote (step S42). The control unit 200 determines the banknote as genuine or as counterfeit (step S43). The banknote determined as counterfeit is collected in the forgery collection box 102 (step S44). The banknote determined as genuine is conveyed to the money in-out slot 100 (step S45). The undeterminable banknote is kept in the temporary storage box 103, if there is any.

The control unit 200 subsequently updates the banknote source data 210, based on the result of discrimination (step S46), as discussed later. The control unit 200 then determines whether all the banknotes required for the sum of money to be paid out have been fed out (step S47). When the feed-out has not yet been completed, the control unit 200 returns the processing to step S41 to feed another required banknote from the corresponding banknote storage box, discriminate the banknote, and updates the banknote source data 210. When the feed-out has been completed, on the other hand, the control unit 200 pays out the required sum of money (step S48).

B3. Update of Banknote Source Data

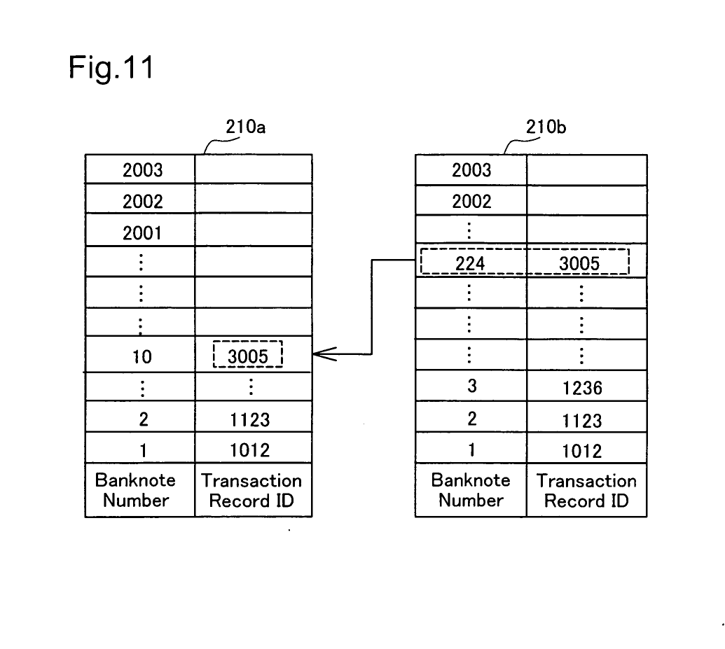

FIG. 11 is a diagram showing a banknote source data update process in the second embodiment. When the banknotes fed from the banknote storage box 104a include any banknote determined as counterfeit in the money-out process, the control unit 200 controls the management module 207 to carry out this banknote source data update process at step S46 in the flowchart of FIG. 10.

Banknote source data 210a are related to the forgery collection box 102, and banknote source data 210b are related to the banknote storage box 104a. A banknote having a banknote number ‘224’ in the banknote storage box 104a was used in a transaction having a transaction record ID ‘3005’. When this banknote is determined as counterfeit in the money-out process, the control unit 200 conveys the banknote to the forgery collection box 102 for collection and moves the transaction record ID ‘3005’ from the banknote number ‘224’ in the banknote source data 210b to a banknote number ‘10’ in the banknote source data 210a corresponding to the forgery collection box 102. The concrete procedure to effectuate this move deletes the transaction record ID ‘3005’ from the banknote source data 210b and newly adds the transaction record ID ‘3005’ to the banknote source data 210a. As one example, when the type of the transaction having the transaction record ID ‘3005’ is ‘banknote feed’, the banknote having the banknote number ‘10’ in the forgery collection box 102 is identified as the banknote received in the automatic teller machine 10 by the banknote feed operation. As another example, when the type of the transaction having the transaction record ID ‘3005’ is ‘deposit’, this arrangement desirably identifies the customer who has paid in the banknote having the banknote number ‘10’ in the forgery collection box 102.

The second embodiment discussed above has the following advantage. Any counterfeit banknote that was included in the banknotes used for a deposit transaction or a banknote feed operation but failed to be determined as counterfeit is stored in one of the banknote storage boxes 104a through 104d. The arrangement of the second embodiment ensures identification of the source of the banknote, which is determined as counterfeit in the money-out process.

### C. Modifications

C1. MODIFIED EXAMPLE 1

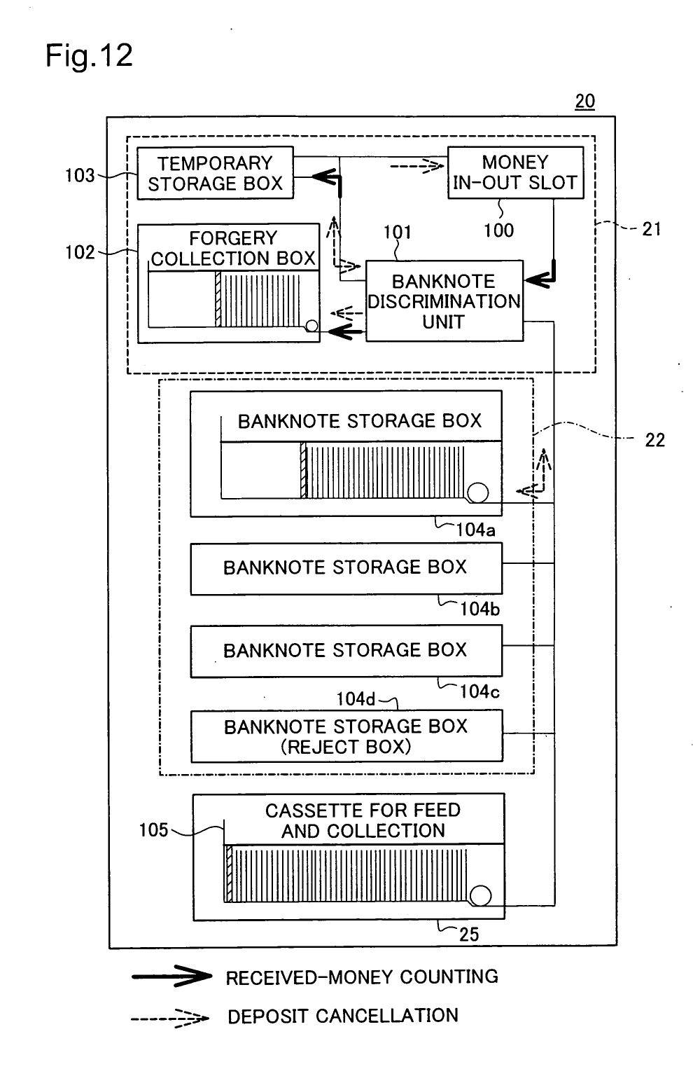

The first embodiment discriminates each banknote and stores the banknote source data in a deposit transaction. This modified example shows a deposit cancellation process in response to the customers deposit cancellation. FIG. 12 is an explanatory view schematically illustrating the structure of the banknote handling mechanism 20 in this modified example. The structure of the banknote handling mechanism 20 in this modified example is identical with that in the first embodiment. The following describes a series of processing in the banknote handling mechanism 20 at the time of a deposit cancellation. The thin lines interconnecting the respective units show a banknote conveyor path for conveyance of banknotes. The arrows of thick line show the flow of banknotes for a received-money counting process. The arrows of broken-line show the flow of banknotes for a deposit cancellation process. The received-money counting process is discussed in the first embodiment and is thus not specifically described here.

On completion of the received-money counting process, the banknotes paid in are kept in the temporary storage box 103. The banknote handling mechanism may be designed to discriminate banknotes determined as counterfeit from the other banknotes and convey the counterfeit banknotes to the forgery collection box 102 at this stage. In response to the customer's transaction cancellation instruction, the banknotes kept in the temporary storage box 103 are conveyed one by one to the banknote discrimination unit 101 for banknote discrimination.

The structure of the banknote handling mechanism 20 does not allow direct conveyance of the banknotes from the banknote discrimination unit 101 to the money in-out slot 100. The banknotes are thus temporarily stored in the banknote storage box 104a. The results of banknote discrimination are temporarily recorded in the banknote source data 210. Hereafter such banknotes are referred to as deposit-cancelled banknotes. When banknote discrimination of all the banknotes kept in the temporary storage box 103 is concluded, the deposit-cancelled banknotes are fed one by one from the banknote storage box 104a, pass through the banknote discrimination unit 101, and are conveyed to the temporary storage box 103. Any banknote determined as counterfeit in the received-money counting process or in the conveyance from the temporary storage box 103 to the banknote storage box 104a is discriminatingly collected in the forgery collection box 102. All the other deposit-cancelled banknotes are conveyed to the temporary storage box 103 and then returned to the money in-out slot 100.

In this modified example, the banknotes may be subjected to banknote discrimination again when being fed from the banknote storage box 104a. This enhances the accuracy of banknote discrimination. In this case, the banknotes determined as counterfeit are temporarily kept in the temporary storage box 103, while the other banknotes are returned to the money in-out slot 100. An additional mechanism may be provided to allow direct conveyance of the banknotes from the banknote discrimination unit 01 to the forgery collection box 102 for storage.

In the deposit cancellation process, the banknotes collected in the forgery collection box 102 are not returned to the customer, so that only the banknotes determined as genuine among the banknotes received from the customer are returned to the customer. In the case of banknote discrimination, information showing that the non-returned banknotes are counterfeit is displayed on the display panel 31 and is described in a transaction statement given to the customer. This notifies the customer of the reason of inconsistency between the paid-in banknotes and the paid-back banknotes.

The procedure of this modified example effectively collects the counterfeit banknotes, which were once determined as genuine in the received-money counting process but are determined as counterfeit in the deposit cancellation process, and manages the banknote source data. This arrangement desirably enhances the accuracy of banknote discrimination and prevents circulation of counterfeit banknotes.

C2. MODIFIED EXAMPLE 2

The first embodiment discriminates each banknote and stores the banknote source data in a banknote feed operation. This modified example collects the banknotes from the banknote storage boxes 104a through 104d into the cassette 105 and takes banknotes out of the automatic teller machine 10 by detachment of the cassette 105 from the automatic teller machine 10.

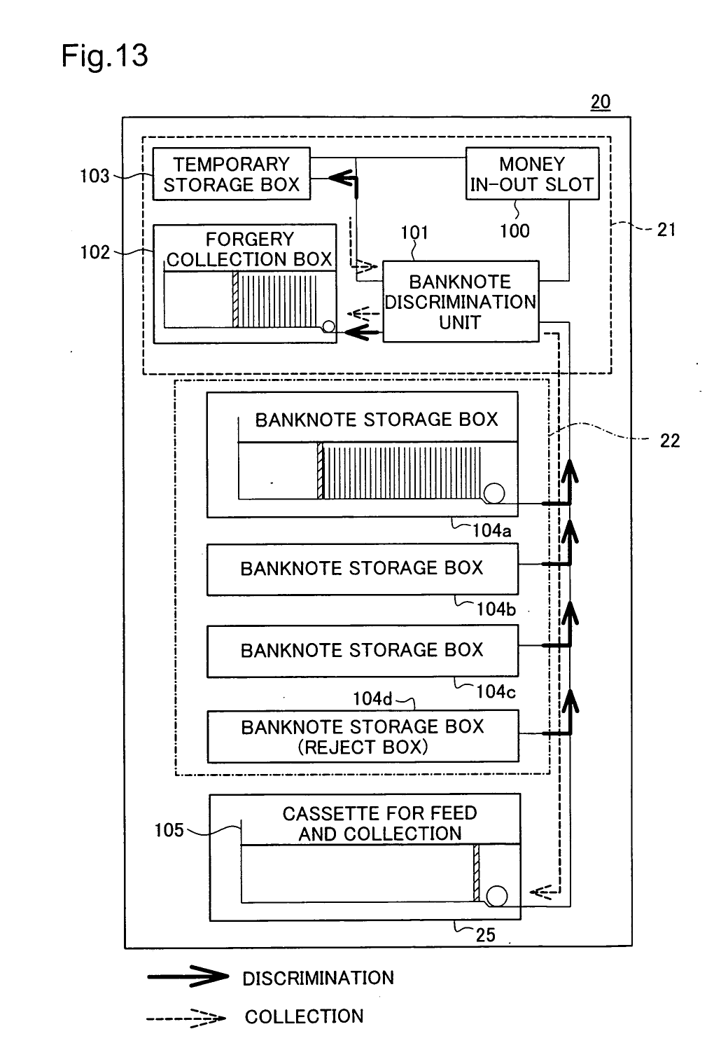

FIG. 13 is an explanatory view schematically illustrating the structure of the banknote handling mechanism 20 in this modified example. The structure of the banknote handling mechanism 20 in this modified example is identical with that in the first embodiment. The thin lines interconnecting the respective units show a banknote conveyor path for conveyance of banknotes. The arrows of thick line show the flow of banknotes for a discrimination process. The arrows of broken-line show the flow of banknotes for a collection process.

In the collection process, the banknotes fed from the banknote storage boxes 104a through 104d are conveyed one by one to the banknote discrimination unit 101 as shown by the arrows of thick line. Any banknote determined as counterfeit by the banknote discrimination unit 101 is collected in the forgery collection box 102. The banknote source data 210 are updated here for management of the source of the counterfeit banknote as in the case of the money-out process. The banknotes determined as genuine by the banknote discrimination unit 101 are temporarily kept in the temporary storage box 103. The processing to this stage is the ‘discrimination process’.

As shown by the arrows of broken line, the banknotes are then conveyed from the temporary collection box 103 to the cassette 105 for collection via the banknote discrimination unit 101. The banknotes may be subjected to banknote discrimination again in the course of conveyance. This arrangement further enhances the accuracy of banknote discrimination. The clerk at the financial institution detaches the cassette 105 from the feed-collection cassette module 25 to collect the banknotes. Even when the banknotes received in a deposit transaction or in a banknote feed operation include any counterfeit banknote, this arrangement advantageous detects such forgery, prior to collection into the cassette 105. This arrangement also ensures management of the banknote source data and improves the convenience.

C3. MODIFIED EXAMPLE 3

In the first embodiment and the second embodiment discussed above, the transaction record is managed by the host computer 1000. The automatic teller machine 10 may alternatively manage the transaction record. In the latter case, it is preferable that the banknote source data include at least information for identifying each customer, for example, an account number.

The technique of the invention is not restricted to the transactions described in any of the above embodiments and modified examples, but is applicable to any transaction that is carried out in the automatic teller machine 10 and is accompanied with conveyance of banknotes. The embodiments regard the circulation-type automatic teller machine, although the invention is also applicable to non-circulation-type automatic teller machines.

The embodiments discussed above are to be considered in all aspects as illustrative and not restrictive. There may be many modifications, changes, and alterations without departing from the scope or spirit of the main characteristics of the present invention. For example, the arrangements discussed above may be combined according to the requirements.

In the automatic teller machine, banknote discrimination of banknotes in any transaction with conveyance of banknotes, in addition to the deposit transaction, desirably enhances the accuracy of banknote discrimination. Management of banknote source data, which identifies the source of each banknote, with respect to each banknote storage box enables an individual responsible for a transaction using any counterfeit banknote to be identified and thus effectively prevents circulation of counterfeit banknotes.

What is claimed is:

1. A banknote handling system, comprising:
a money in-out slot that receives insertion of banknotes from each customer;
a conveyance module that conveys each banknote;
multiple banknote discrimination modules that carry out banknote discrimination of each conveyed banknote in a money-in process that pays in banknotes inserted in said money in-out slot, as well as in another transaction process that is accompanied with conveyance of banknotes;
a banknote storage box that stores a banknote determined as genuine by said banknote discrimination module;
a collection box that collects a banknote determined as counterfeit by said banknote discrimination module; and
a management module that manages information on the transaction process with respect to each banknote.

2. A banknote handling system in accordance with claim 1, said banknote handling system further comprising:
a temporary storage box that temporarily keeps the banknote determined as genuine by said banknote discrimination module in the money-in process, prior to storage of the banknote into said banknote storage box,
wherein the transaction process includes a deposit cancellation process that receives a customer's input of a cancellation instruction and feeds back the banknote temporarily kept in said temporary storage box to said money in-out slot.

3. A banknote handling system in accordance with claim 2, wherein the deposit cancellation process feeds back the banknote temporarily kept in said temporary storage box to said money in-out slot via said banknote storage box.

4. A banknote handling system in accordance with claim 1, wherein the transaction process includes a money-out process that feeds banknotes from said banknote storage box and conveys the banknotes to said money in-out slot.

5. A banknote handling system in accordance with claim 1, wherein the transaction process includes a left-money collection process that stores or collects a banknote, which is left in said money in-out slot after the money-out process, into said banknote storage box or into said collection box.

6. A banknote handling system in accordance with claim 1, wherein the transaction process includes a banknote feed process that supplies banknotes to said banknote storage box from a place other than said money in-out slot.

7. A banknote handling system in accordance with claim 6, said banknote handling system further comprising:
a cassette detachably attached to said banknote handling system,
wherein the banknote feed process feeds out banknotes kept in said cassette attached to said banknote handling system and conveys the banknotes to said banknote storage box for storage.

8. A banknote handling system in accordance with claim 1, said banknote handling system further comprising:
a cassette detachably attached to said banknote handling system,
wherein the transaction process includes a collection process that conveys banknotes from said banknote storage box into said cassette.

9. A banknote handling system in accordance with claim 1, wherein the information on the transaction process includes source data.

10. A banknote handling system in accordance with claim 9, wherein the source data includes transactor information for identifying a transactor.

11. A banknote handling system in accordance with claim 10, wherein the transactor information includes an account number and an employee number.

12. A banknote handling system in accordance with claim 9, wherein the source data includes a transaction record ID used to unequivocally identify a record of the money-in process and the transaction process executed.

13. A banknote handling system in accordance with claim 1, said banknote handling system further comprising:
a banknote sorting module that sorts out each banknote subjected to banknote discrimination by said banknote discrimination module to one of said multiple banknote storage boxes and said collection box,
wherein said management module generates source data, based on a result of banknote discrimination by said banknote discrimination module and a result of sorting by said banknote sorting module.

14. A banknote handling system in accordance with claim 1, said banknote handling system further comprising:
a control unit that, when the transaction process collects banknotes fed from said banknote storage box into said collection box, controls said management module to update source data managed corresponding to said banknote storage box to be related to said collection box.

15. A banknote handling system, comprising:
a banknote storage box that stores banknotes;
a management module that manages source data of each banknote stored in said banknote storage box; and
a control unit that, when a banknote is fed from said banknote storage box, controls said management module to update the source data of the banknote managed corresponding to said banknote storage box.

16. A banknote handling system in accordance with claim 15, wherein said management module manages the source data with a banknote number sequentially allocated to each banknote stored in said banknote storage box, and
when a banknote is fed from said banknote storage box, said control unit changes the banknote number allocated to the banknote.

17. A banknote handling system in accordance with claim 15, sad banknote handling system further comprising:
a banknote discrimination module that carries out banknote discrimination of each banknote;
a collection box that collects a banknote determined as counterfeit by sad banknote discrimination module,
wherein said control unit updates the source data of the banknote managed corresponding to said banknote storage box to be related to said collection box, when the banknote is fed from said banknote storage box.

18. A banknote handling system in accordance with claim 15, wherein the source data include customer information on a customer who has paid in banknotes or an employee information on an employee who has fed banknotes.

19. A banknote handling system in accordance with claim 15, wherein the source data include transaction information for unequivocally identifying a transaction process executed by said banknote handling system and other information, and
said control unit updates only the other information included in the source data.

20. A banknote handling method in a banknote handling system, said banknote handling method comprising:
a first step that obtains transactor information;
a second step that carries out banknote discrimination of each banknote paid in or fed;
a third step that stores a banknote determined as genuine in said second-step into a banknote storage box;
a fourth step that manages mapping of the transactor information obtained in said first step and a result of banknote discrimination in said second step with respect to each banknote, to said banknote storage box for storing the banknote in said third step;
a fifth step that feeds out the banknote stored in said third step and carries out banknote discrimination of the banknote;
a sixth step that collects a banknote determined as counterfeit in said fifth step into a collection box, which is different from said banknote storage box; and
a seventh step that updates the mapping to said banknote storage box managed in said fourth step to be related to said collection box, with respect to the banknote collected in said sixth step.
